(19) United States
(12) Patent Application Publication
(10) Pub. No.: US 2022/0352765 A1
(43) Pub. Date: Nov. 3, 2022

(54) WIRELESS POWER TRANSMITTER WITH PASSIVE WIRELESS POWER RECEIVER DETECTION

(71) Applicant: Aptiv Technologies Limited, St. Michael (BB)

(72) Inventor: James Cook, Poland, OH (US)

(21) Appl. No.: 17/731,887

(22) Filed: Apr. 28, 2022

Related U.S. Application Data
(60) Provisional application No. 63/182,146, filed on Apr. 30, 2021.

(51) Int. Cl. H02J 50/90; H02J 50/10

(52) U.S. Cl. CPC H02J 50/90; H02J 50/10

(57) ABSTRACT

A wireless power transmission system includes a wireless power receiver and a wireless power transmitter. The wireless power receiver includes at least one permanent magnet and the wireless power transmitter includes a magnetic senor configured to detect proximity of the at least one permanent magnet.

### CROSS REFERENCE TO RELATED APPLICATION(S)

This patent application claims the benefit of U.S. Provisional Application No. 63/182,146, filed Apr. 30, 2021 which is incorporated by reference in its entirety.

### TECHNICAL FIELD OF THE INVENTION

The invention generally relates to a wireless power transmission system for charging batteries in a consumer electronic device, particularly a wireless power transmitter configured to passively detect the proximity of a wireless power receiver having an array of magnets surrounding its receiving coil.

### BACKGROUND

Wireless power transmitters, such as those used to charge batteries in consumer electronics devices having a corresponding wireless power receiver, typically use an object detection system to determine if the receiver is in proximity before attempting to establish a charging session to avoid wastefully emitting radio frequency electromagnetic energy and transmitting power when not in use. This may be accomplished by periodically energizing the source coil or coils in the transmitter for a short duration to sense if there is a receiver nearby. A change in the load on the source coil may indicate the presence of a receiver. Alternatively, capacitive touch sensing which uses an active electrode to detect the presence of an object touching the surface by changes in capacitance may be employed. Both test pulse sensing and capacitive touch sensing require energizing a coil or sensor, which both create significant electromagnetic energy emissions and increase quiescent current consumption of the transmitter.

### SUMMARY OF THE INVENTION

According to one aspect, a wireless power transmission system includes a wireless power receiver and a wireless power transmitter. The wireless power receiver includes at least one permanent magnet and the wireless power transmitter includes a magnetic senor configured to detect proximity of the at least one permanent magnet.

According to another aspect, a method of detecting proximity of a wireless power receiver to a wireless power transmitter includes placing the wireless power receiver in proximity to the wireless power transmitter, wherein the wireless power receiver contains at least one permanent magnet. The method further includes inducing a voltage or current across a source coil in the wireless power transmitter via movement of the at least one permanent magnet relative to the source coil and detecting the voltage or current via an electronic controller that is in electrical communication with the source coil.

According to another aspect, a wireless power transmission system includes a wireless power receiver and a wireless power transmitter. The wireless power receiver includes at least one permanent magnet. The wireless power transmitter includes a source coil and an electronic controller, wherein the electronic controller monitors the source coil for induced voltages/currents to detect proximity of the wireless power receiver. In response to detected proximity of the wireless power receiver the electronic controller enables a supply of power to the source coil to initiate wireless charging between the wireless power transmitter and the wireless power receiver.

### BRIEF DESCRIPTION OF THE DRAWINGS

The present invention will now be described, by way of example with reference to the accompanying drawing, in which:

FIG. 1 is a schematic cross section view of a wireless power transmission system in accordance with some embodiments; and

FIG. 2 is a graph of a current in a coil in a transmitter of the wireless power transmission system that is induced by a magnet in a receiver of the wireless power transmission system in accordance with some embodiments.

### DETAILED DESCRIPTION

Some wireless power transmission systems, such as the MagSafe® wireless power transmission system developed by Apple, Inc. of Cupertino, Calif., use an array of permanent magnets in the wireless power transmitter that interface with a corresponding array of permanent magnets in the wireless power receiver. The magnets in the transmitter and the receiver have compatible polarizations that cause the receiver to be properly aligned with the transmitter and provide physical retention of the receiver to the transmitter. This provides optimal alignment between a receiving coil in the receiver and a source coil in the transmitter, thereby allowing a maximum power transmission between the transmitter and the receiver.

The problem of detecting the proximity of the receiver to the transmitter without employing active components that need to emit radio frequency electromagnetic energy and consume quiescent current may be solved by using the source coil, a sense coil, or solid-state magnetic or electric field sensors in the transmitter to detect motion of nearby permanent magnets that are part of, or attached to, the receiver that are used for attachment to and/or alignment with a transmitter.

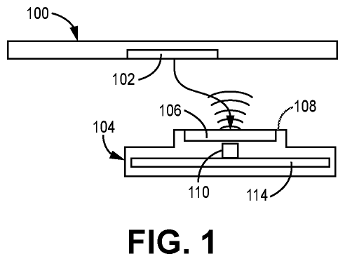

FIG. 1 is a schematic cross section view of a wireless power transmission system that includes a wireless power receiver 100 and a wireless power transmitter 104. The wireless power receiver 100 includes a receiver coil (not shown) as well as an integrated attachment/alignment magnet 102. In some embodiments, the integrated attachment/alignment magnet 102 is a permanent magnet. The wireless power transmitter 104 includes a magnetic sensor configured to detect the presence of the integrated attachment/alignment magnet 102. In some embodiments, the magnetic sensor is a coil configured to detect the presence of a moving or dynamic magnetic field that results from the receiver 100 and magnet 102 located therein moving relative to the coil located within the transmitter 104 (i.e., as the receiver 100 is placed on an interface surface 108 of the transmitter 104). In other embodiments, the magnetic sensor located on the transmitter 104 is configured to detect the presence of a static magnetic field (i.e., magnetic field resulting from the receiver 100 being statically located on the interface surface 108 of the transmitter 104).

With respect to utilizing a coil to detect the presence of a moving or dynamic magnetic field caused by the relative movement of the wireless receiver 100 relative to the wireless transmitter 104, several different options are available. In some embodiments, the wireless power transmitter 104 includes a source coil 106 utilized both as a charging coil and as a magnetic sensor to detect the presence of the wireless power receiver 100. In other embodiments, the wireless power transmitter 104 includes a source coil 106 utilized to provide wireless charging power to the wireless power receiver 100 and a secondary, proximity coil (not shown) to detect the presence of the wireless power receiver 100. In embodiments in which the source coil 106 is utilized as both a charging coil and to detect the presence of the wireless power receiver 100, the secondary, proximity coil may not be necessary, or may be utilized as a redundant system for detecting the presence of the wireless power receiver 100.

In the embodiments in which the source coil 106 is utilized both as a charging coil and to the detect the presence of the wireless power receiver 100, the action of placing the wireless power receiver 100 with the integrated attachment/alignment magnet 102 on the interface surface 108 of the wireless power transmitter 104 results in relative movement between the attachment/alignment magnet 102 and the source coil 106. The movement of the magnetic field generated by the attachment/alignment magnet 102 through the coils of the source coil 106 induces a current/voltage across the source coil 106. By sensing the induced current/voltage across the source coil 106, the presence of the attachment/alignment magnet 102, and therefore the presence of the wireless receiver coil 100, may be detected. In some embodiments, an electronic controller 112 is configured to monitor the induced current/voltage generated across the source coil 106. Based on the monitored induced current/voltage, the electronic controller 112 determines whether the wireless power receiver 100 has been placed on the interface surface 108 of the wireless power transmitter 104. In response to detection of the wireless power receiver 100, the electronic controller 112 enables or initiates the supply of power to the source coil 106 to initiate wireless charging between the wireless power transmitter 104 and the wireless power receiver 100. In some embodiments, the electronic controller 112 detects the presence of the wireless power receiver 100—in particular, the presence of the attachment/alignment magnet 102—by comparing the monitored voltage of the source coil 106 to one or more threshold values. In some embodiments, the one or more threshold values may include a positive threshold value and a negative threshold value.

In the embodiment shown in FIG. 1, the source coil 106 is utilized both as a proximity detector for the wireless power receiver 100 and a charging coil for communicating wireless power to the wireless power receiver 100. In other embodiments, a proximity coil is provided separate from the source coil 106 to detect the presence of the wireless power receiver 100. The principles of detection remain the same.

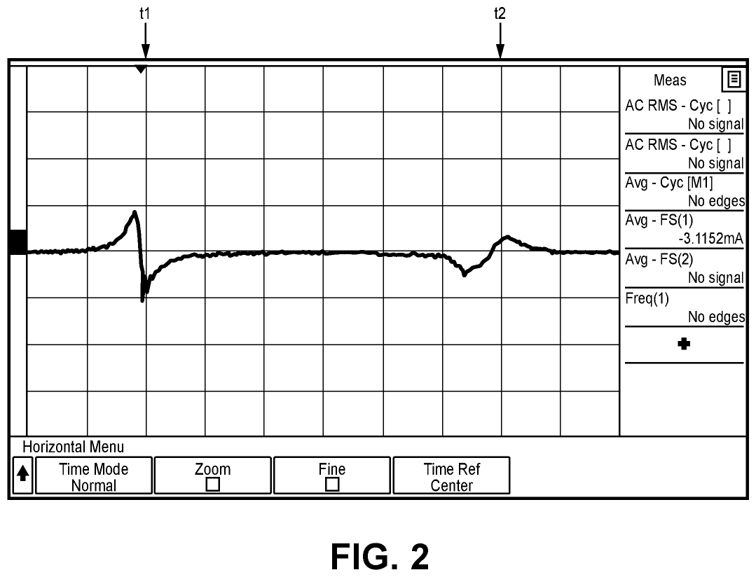

FIG. 2 is a graph of a current in the source coil 106 in the transmitter 104 of the wireless power transmission system that is induced by a magnet in the receiver 100 of the wireless power transmission system. At time t1, the wireless power receiver 100 is placed on the wireless power transmitter 104. Movement between the wireless power receiver 100 relative to the wireless power transmitter 104 induces a detectable current in the source coil 106. By comparing the measured current to a threshold level the wireless power transmitter 104 is capable of detecting the placement of the wireless power receiver 100 on the wireless power transmitter 104. As shown in FIG. 2, the induced current caused by the placement of the wireless power receiver 100 on the wireless power transmitter 104 includes both a positive peak and a negative peak. In some embodiments, the induced current is compared to both a positive current threshold and a negative current threshold to detect the presence of the wireless power receiver 100. At time t2, the wireless power receiver 100 is removed from the wireless power transmitter 104, and again the movement of the attachment/alignment magnet 102 relative to the source coil 106 induces a current in the source coil 106 that is detectable. Once again, the induced current has both a positive and negative component, and therefore in some embodiments the monitored current may be compared to both a positive threshold and/or a negative threshold to detect movement of the wireless power receiver 100 relative to the wireless power transmitter 104. In other embodiments, an induced voltage may be monitored in the source coil 106 representative of the induced current.

Referring once again to FIG. 1, in some embodiments rather than use the source coil 106 (or another proximity coil) to detect the relative motion between the wireless power receiver 100 and the wireless power transmitter 104, a magnetic field sensor 110 may be utilized to detect the presence of the wireless power receiver 100. In some embodiments, the magnetic field sensor 110 once again detects the presence of the attachment/alignment magnet 102, but not the relative motion of the wireless power receiver 100 relative to the wireless power transmitter 104. Rather, the magnetic field sensor 110 detects the DC magnetic field generated by the attachment/alignment magnet 102 when the wireless power receiver 100 has been placed on the wireless power transmitter 104. In some embodiments, the magnetic field sensor 110 is a solid-state device. In some embodiments, the magnetic field sensor 110 is a Hall effect sensor, a giant magnetoresistive sensor, or a magnetic reed sensor capable of detecting the presence of a magnetic field. In some embodiments, the magnetic field sensor 110 is coupled to the electronic controller 112, wherein in response to the magnetic field sensor 110 detecting the presence of a magnetic field (presumably created by the presence of the attachment/alignment magnet 102), the electronic controller 112 enables or initiates the supply of power to the source coil 106 to initiate wireless charging between the wireless power transmitter 104 and the wireless power receiver 100. In order to also be able to detect the presence of a receiver that does not contain permanent magnets, an active inductive or capacitive sensing method may also be used periodically.

Benefits of the wireless power transmitter 104 include eliminating the need to actively sense the proximity of the wireless power receiver 100, thereby reducing electromagnetic transmissions and eliminating the power consumption required to make those transmissions. The wireless power transmitter 104 makes use of the permanent magnet or magnets 102 already integrated into the wireless power receiver 100 for attachment/alignment purposes and therefore requires no modification or additional cost in the receiver 100. If the source coil 106 is used to detect the magnet or magnets 102 in the receiver 100, the cost of implementation is minimal because no additional components need to be added to the transmitter 104 for passive sensing.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

We claim:

1. A wireless power transmission system, comprising:
a wireless power receiver containing at least one permanent magnet; and
a wireless power transmitter containing a magnetic senor configured to detect proximity of the at least one permanent magnet.

2. The wireless power transmission system according to claim 1, wherein the magnetic sensor is a coil.

3. The wireless power transmission system according to claim 2, wherein the coil is a source coil of the wireless power transmitter utilized to provide wireless charging power to the wireless power receiver.

4. The wireless power transmission system according to claim 2, wherein the wireless power transmitter includes a source coil and a secondary proximity coil, wherein the secondary proximity coil is utilized to detect proximity of the at least one permanent magnet.

5. The wireless power transmission system according to claim 1, wherein the magnetic sensor is a solid-state device.

6. The wireless power transmission system according to claim 1, wherein the magnetic sensor is selected from a list consisting of a Hall effect sensor, giant magnetoresistance sensor, and magnetic reed sensor.

7. The wireless power transmission system according to claim 1, wherein the wireless power transmitter further includes an electronic controller that communicates with the magnetic sensor to detect proximity of the wireless power receiver.

8. The wireless power transmission system according to claim 7, wherein the wireless power transmitter further includes a source coil, wherein the electronic controller enables the supply of power to the source coil to initiate wireless charging between the wireless power transmitter and the wireless power receiver in response to detected proximity of the wireless power receiver.

9. The wireless power transmission system according to claim 7, wherein the electronic controller monitors induced currents/voltages of the source coil to detect proximity of the wireless power receiver.

10. The wireless power transmission system according to claim 9, wherein the electronic controller compares the monitored currents/voltages to threshold values to detect proximity of the wireless power receiver.

11. A method of detecting proximity of a wireless power receiver to a wireless power transmitter, comprising:
placing the wireless power receiver in proximity to the wireless power transmitter, wherein the wireless power receiver contains at least one permanent magnet;
inducing a voltage or current across a source coil in the wireless power transmitter via movement of the at least one permanent magnet relative to the source coil; and
detecting the voltage or current via an electronic controller that is in electrical communication with the source coil.

12. The method of claim 11, wherein the electronic controller compares the detected voltage or current to a threshold to determine proximity of the wireless power receiver.

13. The method of claim 11, wherein the electronic controller enables a supply of power to the source coil to initiate wireless charging between the wireless power transmitter and the wireless power receiver.

14. A wireless power transmission system, comprising:
a wireless power receiver containing at least one permanent magnet; and
a wireless power transmitter containing a source coil and an electronic controller, wherein the electronic controller monitors the source coil for induced voltages/currents to detect proximity of the wireless power receiver, wherein in response to detected proximity of the wireless power receiver the electronic controller enables a supply of power to the source coil to initiate wireless charging between the wireless power transmitter and the wireless power receiver.

15. The wireless power transmission system of claim 14, wherein electronic controller compares the monitored voltages/currents to threshold values to detect proximity of the wireless power receiver.
